(19) United States
(12) Patent Application Publication
(10) Pub. No.: US 2008/0156931 A1
(43) Pub. Date: Jul. 3, 2008

(54) CABLE SUPPORT FOR AERONAUTIC CONSTRUCTION

(75) Inventors: Pierre Charon, Toulouse (FR); Olivier Picot, Blagnac (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Airbus France, Toulouse (FR)

(21) Appl. No.: 11/837,705

(22) Filed: Aug. 13, 2007

(30) Foreign Application Priority Data
Aug. 18, 2006 (FR) 0607379

(51) Int. Cl. B64F 1/02; F16L 3/00

(52) U.S. Cl. 244/110 C; 248/49

(57) ABSTRACT

Support for cables intended in particular for aeronautic construction This support is provided with a metal profiled structure (2) having at least one housing (10) intended to receive cables (4) or similar components. This structure (2) in turn has a face intended to be braced against a load-bearing wall, and the said face is covered with a layer of insulating material (12).

The present invention relates to a cable support intended in particular for aeronautic construction.

In an aircraft, it is known to use a cable support provided on the one hand with a structure inside which the supported cables are housed and on the other hand with a cover that encloses and maintains the cable assembly housed in the structure.

As an example, the structure is a profiled structure provided with a base plane, on one side of which there extend longitudinal walls perpendicular to the base and parallel to one another. Two neighboring longitudinal walls therefore form a throat (“channel” in English) intended to serve as the cable housing.

Each channel can be equipped with a cover, or else the same cover can cover a plurality of channels. As an example, each cover is maintained by a self-locking serrated rack system. Such a system is provided with a serrated rack, made of synthetic material, for example, extending from the base of the structure toward the open side of the channel. The cover is then provided with an aperture dimensioned in such a way that the serrated rack of synthetic material can pass through the aperture in one direction but not in the other. It is understood that the serrated rack is oriented in such a way that the cover can be displaced toward the bottom of the channel, or in other words toward the base of the structure.

The known cable support structure are generally made of metal. Such a support provides of diverse functions. Firstly it supports and mechanically protects cables and/or cable harnesses. By virtue of the presence of a plurality of channels, it also achieves physical separation of diverse cables. The cable support also provides heat removal by conduction and protection of the cables from electromagnetic interferences to which they may be exposed. In particular, this latter function obviates the need for excessive shielding of the cables.

The majority of aircraft are provided with a metal structure, which provides a return path for the current carried by the cables housed in the cable supports. Aircraft of modern design are increasingly using structural parts of composite material. The return path for the current is then no longer provided by the structure. It is therefore appropriate to provide a current return path. Such a return path is then achieved by a separate electrical connection comprising an aluminum wire or rod to provide a return path for the current being carried. The drawback of this solution is that it increases the weight installed on board the aircraft.

The objective of the present invention is then to provide a solution with which cable supports can be used in an aircraft in such a way as to retain the advantages of this support without detriment to the weight of the aircraft.

To this end it proposes a cable support intended in particular for aeronautic construction, provided with a metal profiled structure having at least one housing intended to receive cables or similar components, this structure having a face intended to be braced against a load-bearing wall.

According to the present invention, the face intended to be braced is covered with a layer of insulating material.

In this way, the profiled structure can be used to provide a return path for the current carried by cables housed in the structure. The layer of insulating material makes it possible to prevent current leakages, in order to provide an efficient current return path. Without appreciable increase in the weight of the support, the latter achieves a new function that it has never achieved heretofore.

According to a first embodiment, the profiled structure is provided with a base plate that on one of its faces supports longitudinal walls, each extending in a plane substantially perpendicular to the base plate, and the layer of insulating material covers the face of the base plate opposite the longitudinal walls.

To permit better insulation of the cables, each housing is covered, for example, by a layer of insulating material.

The insulating material used both to insulate the profiled structure of the load-bearing wall on which it is intended to be fixed and to insulate the cables in their housing is, for example, an insulating varnish. It may also be a fluoro polymer, such as polyvinyl fluoride (PVF).

In an alternative embodiment of a cable support according to the invention, this support is provided with at least two fixation feet, and each foot is provided on the one hand with a first bore intended for fixation thereof on a load-bearing wall and on the other hand with a second bore intended to permit fixation of a metal braid. In this way, it is possible to connect two profiled structures to one another electrically and in this way to provide a return path for the current effectively by using a plurality of cable supports disposed one after another.

In an advantageous embodiment, the base plate of a cable support according to the invention is provided in proximity to its longitudinal rims with fixation bores. These bores can then be used for fixation of electrical connections (ground leads, connections to an equipment item, etc.).

The present invention also relates to a set of at least two cable supports such as described hereinabove, characterized in that the supports are connected electrically to one another.

The present invention is also aimed at protecting the use of a support such as described hereinabove, inside which there are seated cables for achieving a return path for the current flowing in the cables.

Finally, the present invention relates to an aircraft, characterized in that it is provided with a cable support such as described hereinabove.

Details and advantages of the present invention will become clearer from the description hereinafter, provided with reference to the attached schematic drawings, wherein:

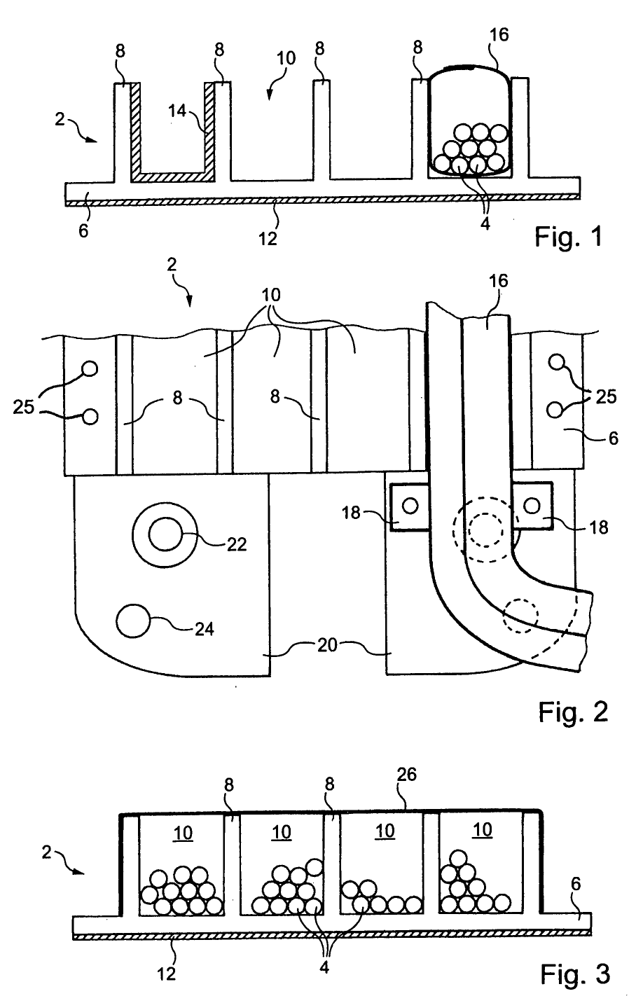

FIG. 1 is a view in transverse section of an aircraft cable support according to the invention,

FIG. 2 is a view from above of one end of the support of FIG. 1, and

FIG. 3 corresponds to FIG. 1 for an alternative embodiment of a support according to the invention.

The drawings represent a cable support provided on the one hand with a structure 2 intended to house cables 4 and on the other hand with means for maintaining cables 4 in their housing.

Structure 2 is a metal structure provided with a base plate 6 and longitudinal walls 8. It will be assumed, for example, in the description hereinafter, that base plate 6 extends in a horizontal plane, while the longitudinal walls are disposed in a vertical plane. Base plate 6 and longitudinal walls 8 form a metal profile of length adapted to the surrounding constraints.

Longitudinal walls 8 all extend perpendicular to base plate 6 on the same side thereof. They are parallel to one another and, in the illustrated embodiment, they are equidistant and distributed over base plate 6. Thus two neighboring longitudinal walls 8 together with base plate 6 define a channel-shaped housing 10 extending over the entire cable support length.

This structure 2 is a structure made of electrically conductive metal. It permits mechanical protection and physical separation of cables 4 and also makes it possible to provide a return path for the current flowing in cables 4. The fact that profiled structure 2 is intended to be used to provide a return path for the current makes it possible to improve the susceptibility to ground loops (the outgoing wires being as close as possible to the return path achieved by structure 2) and to achieve a low parasitic inductance.

To insulate structure 2, it is provided that base plate 6 will be covered on the side opposite longitudinal walls 8 with a layer of insulating material 12. This layer can be, for example, a layer of synthetic material (such as polyvinyl fluoride) overmolded onto the base plate, or it can be a coat of varnish deposited on that plate.

It is also possible to provide a layer of insulating material 14 in each housing 10. In FIG. 1, only one layer of insulating material 14 is illustrated for a single housing 10. Of course, all housings 10 can receive such a layer of insulating material 14. This layer is a continuous layer covering each longitudinal wall 8 as well as the bottom of housing 10 formed by part of the upper face of base plate 6 (it is assumed here that the layer of insulating material 12 covers the lower face of base plate 6).

In the embodiment of FIGS. 1 and 2, cables 4 are maintained inside their housing 10 by a fastening system 16.

In this first embodiment, fastening system 16 has the form of a flexible tubular sheath. This sheath has an aperture along a longitudinal edge. A hook-and-loop fastening system of the type of fastening systems sold under the trademark Velcro is advantageously used here to fasten the sheath of fastening system 16 over its entire length. This sheath has a conductive core. Thus this sheath makes it possible to achieve protection of cables 4 against electromagnetic interferences. By using such a fastening system 16 with metal core, there is no need to provide a layer of insulating material 14 in housings 10.

The sheath of fastening system 16 has the advantage that it can be prolonged beyond the structure of a cable support. Thus a given fastening system 16 can be prolonged over a plurality of profiles forming a cable support. Cables 4 are then protected over their entire length, even while passing from one profiled structure 2 to another.

A fastening system 16 can be fixed in different ways in a housing 10. As an example, the sheath of fastening system 16 can be bonded adhesively to the inside of a housing 10 against base plate 6 and/or one or two longitudinal walls 8. Fixation lugs 18 can be provided instead of or in addition to the applied adhesive bonding. FIG. 2 shows an example of fixation lugs 18. At the end of a structure 2 of a cable support, the sheath of fastening system 16 is provided laterally on both sides with a fixation lug 18 of substantially rectangular shape. A bore is then provided in each fixation lug 18 to permit fixation thereof to structure 2.

As can be seen in FIG. 2, base plate 6 of structure 2 has, at its ends, two feet 20 that extend in the prolongation of base plate 6. In the illustrated embodiment, there is provided in each foot 20 a first bore 22 to fix structure 2 against a wall, for example, as well as a second bore 24, with which metal structure 2 can be connected to another metal structure 2 by means, for example, of a metal braid (not illustrated).

It is also evident in FIG. 2 that base plate 6 has bores 25 close to its longitudinal rims. These bores are distributed regularly along these rims. They can be used for fixation of a secondary current-return system (grounding) or for connecting the support electrically to other equipment items (bonding). These bores 25 also contribute to making structure 2 more lightweight.

FIG. 3 shows an alternative embodiment of the invention. In this case, maintenance of cables 4 inside housings 10 of structure 2 is provided by a flexible cover 26. This cover is also fixed on structure 2 by means, for example, of a hook-and-loop fastening system sold under the trademark Velcro. In one embodiment, it can be provided that the outer faces of end longitudinal walls 8 are covered with a sheet bearing hooks (or loops). Flexible cover 26 then in turn has a face covered with loops (or hooks). Like the sheath of fastening system 16 of FIGS. 1 and 2, this cover 26 is made of a composite material provided with a conductive metal core. In this preferred embodiment, flexible cover 26 itself also makes it possible to provide protection of the cables against electromagnetic interferences. The free ends of longitudinal walls 8 can themselves also have hooks (or loops) to permit fixation of flexible cover 26.

A support such as described hereinabove can be used to conduct the current. It therefore makes it possible to provide a return path for the current carried by the cables 4 that it supports.

The systems making it possible to maintain cables 4 in their housing 10 are on the one hand very easy to use and on the other hand lighter than the traditionally used covers, while also being just as effective as the latter. These devices, which permit cables 4 to be maintained in their housing 10, also achieve protection against electromagnetic interferences when they are provided with a metal core.

The invention described hereinabove therefore makes it possible to retain the advantages of cable supports used traditionally in an aircraft, while offering advantages in terms both of protection against electromagnetic interferences and of weight. The cost price of a cable support according to the invention may even be lower than the cost price of a prior art cable support.

The present invention is not limited to the embodiments described above by way of non-limitative examples. It also relates to all variations of construction conceivable by the person skilled in the art within the scope of the appended claims.

1. A cable support intended in particular for aeronautic construction and provided with a metal profiled structure (2) having at least one housing (10) intended to receive cables (4) or similar components, this structure (2) having a face intended to be braced against a load-bearing wall,
characterized in that the face intended to be braced is covered with a layer of insulating material (12).

2. A cable support according to claim 1, characterized in that the profiled structure (2) is provided with a base plate (6) that on one of its faces supports longitudinal walls (8), each extending in a plane substantially perpendicular to the base plate (6), and in that the layer of insulating material (12) covers the face of the base plate (6) opposite the longitudinal walls (8).

3. A cable support according to one of claims 1 or 2, characterized in that each housing (10) is covered by a layer of insulating material (14).

4. A cable support according to one of claims 1 to 3, characterized in that the insulating material used is an insulating varnish.

5. A cable support according to one of claims 1 to 3, characterized in that the insulating material used is a fluoro polymer, such as polyvinyl fluoride (PVF).

6. A cable support according to one of claims 1 to 5, characterized in that it is provided with at least two fixation feet (20), and in that each foot (20) is provided on the one hand with a first bore (22) intended for fixation thereof on a load-bearing wall and on the other hand with a second bore (24) intended to permit fixation of a metal braid.

7. A cable support according to one of claims 1 to 5, characterized in that the base plate (6) is provided in proximity to its longitudinal rims with fixation bores.

8. An assembly of at least two cable supports according to one of claims 1 to 7, characterized in that the supports are connected electrically to one another.

9. The use of a cable support according to one of claims 1 to 7, inside which there are seated cables (4) for achieving a return path for the current flowing in the cables (4).

10. An aircraft, characterized in that it is provided with a cable support according to one of claims 1 to 7.
